(19) United States
(12) Patent Application Publication
(10) Pub. No.: US 2018/0322788 A1
(43) Pub. Date: Nov. 8, 2018

(54) VEHICLE WARNING SYSTEM

(71) Applicants: Allbridge Rogers, Hanover, PA (US); Hoston Rogers, Hanover, PA (US)

(72) Inventors: Allbridge Rogers, Hanover, PA (US); Hoston Rogers, Hanover, PA (US)

(21) Appl. No.: 15/972,078

(22) Filed: May 4, 2018

Related U.S. Application Data
(60) Provisional application No. 62/501,634, filed on May 4, 2017.

(51) Int. Cl. G08G 1/16; G01S 17/93; G01S 17/08

(52) U.S. Cl. CPC G08G 1/167; G01S 17/08; G01S 17/936; G08G 1/166

(57) ABSTRACT

A vehicle warning system is a warning system that is able to alert a vehicle driver that there is a vehicle in the blind spot on either side of the vehicle. The system uses a transmitter on each side of the vehicle that emits a beam which reflects off an adjacent vehicle or object and is received again by a receiver on the transmitting vehicle. The received signal activates a convenient warning system for the driver of the presence of the object.

### CROSS-REFERENCE TO RELATED APPLICATION

The present application is related to and claims priority from prior provisional application Ser. No. 62/501,634, filed May 4, 2017 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of warning devices and more specifically relates to a vehicle warning system.

### 2. Description of the Related Art

Automobile accidents happen every day in most countries. These types of accidents generally account for the largest category of causes for injury and death. Vehicle accident statistics have been broken down into accident type being categorized by cause in some studies. One of those categories is unsafe lane changes. The general mistake made when an unsafe lane change occurs is not verifying that the adjacent lane is vacant. There are many variables within this category such as excessive speed of the driver or of other drivers, road obstructions, and sudden maneuvering of other drivers. The vehicle driver often makes a snap judgment to change lanes because of having only a small window of time to react, but would have reacted differently if he had known with certainty that the lane was occupied.

The problem exists because modern vehicles by nature have two blind spots. On each side of nearly every vehicle there is a rearview mirror for viewing a portion of the area beside and behind the vehicle. A large percentage of the total area surrounding the sides and rear of the vehicle is visible through the mirrors, however, there is a space located at about 45 degrees behind the vehicle driver on each side of the vehicle that is not readily seen by the driver that is also large enough for a vehicle to fit in. Add to this that for some reason many drivers of other vehicles seem to be comfortable driving next to other vehicles within one of these blind spots, never realizing the hazard they are causing. Craning the neck while looking backwards to attempt to see into these blind spots is more often than not dangerous also. With today's technology, it is mystifying that there hasn't been more attention given to this safety issue. A solution is needed.

Various attempts have been made to solve the problem but are either cost prohibitive or ineffective. None of the existing inventions and patents, taken either singly or in combination, is seen to describe the invention as claimed.

Ideally, a warning device for vehicles should provide comfort and effectiveness, and yet, would operate reliably and be manufactured at a modest expense. Thus, a need exists for a reliable vehicle warning system to avoid the above-mentioned problems.

### BRIEF SUMMARY OF THE INVENTION

In view of the foregoing disadvantages inherent in the known warning device art, the present invention provides a novel vehicle warning system. The general purpose of the present invention, which will be described subsequently in greater detail, is to provide ease of use and convenient notification of adjacent vehicles.

A vehicle warning system may comprise at least one transmitter adapted to be attached to the side view mirrors of an automobile and radiate waves outward therefrom, at least one receiver adapted to be attached to portions of the automobile and receive the radiated waves sent by a respective transmitter after being redirected by objects in proximity to the automobile, a warning member that is electronically connected to the receiver(s) and adapted to provide a warning signal to a driver of the automobile when an object is detected in proximity to the automobile, and a power source connected to and adapted to provide electric power to the transmitter(s), the receiver(s), and the warning member.

There is one transmitter(s) attached to a driver's side rearview mirror and one attached to a passenger's side rearview mirror. There are two receivers, one attached to a driver's side portion of the automobile and one attached to a passenger's side portion of the automobile. The two receivers may be attached to the driver's side view mirror and the passenger's side view mirror respectively. The warning member is preferably formed as a flashing yellow light member but may be formed as an audible sound. The radiated waves from the transmitter(s) are preferably in the form of infrared light, but in some embodiments, the radiated waves may be in the form of electromagnetic radiation.

The invention may be formed as a combination of an automobile and a vehicle warning system and may comprise an automobile having a driver's side view mirror, a passenger's side view mirror, a driver's side door, a passenger's side door, an interior cabin, a power source, and a vehicle warning system comprising at least one transmitter adapted to be attached to the driver's and the passenger's side view mirrors of the automobile to radiate waves therefrom, at least one receiver adapted to be attached to portions of the automobile and receive radiated waves sent by a respective transmitter after being redirected by objects in proximity to the automobile, and a warning member electronically connected to at least one receiver that is located within the interior cabin of the automobile and adapted to provide a warning signal to a driver of the automobile when an object is detected in proximity to the automobile.

The power source of the automobile is connected to and adapted to provide electric power to the transmitter(s), the receiver(s), and the warning member. There are two transmitters respectively attached to the driver's side view mirror and the passenger's side view mirror and there are two receivers respectively attached to the driver's side door of the automobile and the passenger's side door of the automobile.

The two receivers may be respectively attached to the driver's side view mirror and the passenger's side view mirror. The warning member may be formed as a flashing yellow light member, an audible sound, or may be formed as a lighted visual symbol. The radiated waves from the transmitter(s) may be in the form of infrared light or may be in the form of electromagnetic radiation.

The present invention holds significant improvements and serves as a vehicle warning system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a vehicle warning system, constructed and operative according to the teachings of the present invention.

FIG. 1 shows an overhead view illustrating a vehicle warning system according to an embodiment of the present invention.

FIG. 2 is a perspective view illustrating an in-use condition of the vehicle warning system according to an embodiment of the present invention of FIG. 1.

FIG. 3 is a diagram illustrating the vehicle warning system according to an embodiment of the present invention of FIG. 1.

FIG. 4 is an overhead view illustrating a combination of an automobile and a vehicle warning system vehicle warning system according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a warning device and more particularly to a vehicle warning system as used to improve the ease of use and convenient notification of adjacent vehicles.

Generally speaking, a vehicle warning system is a warning system that is able to alert a vehicle driver that there is a vehicle in the blind spot on either side of the vehicle. The system uses a transmitter on each side of the vehicle that emits a beam which reflects off an adjacent vehicle or object and is received again by a receiver on the transmitting vehicle. The received signal activates a convenient warning system for the driver of the presence of the object.

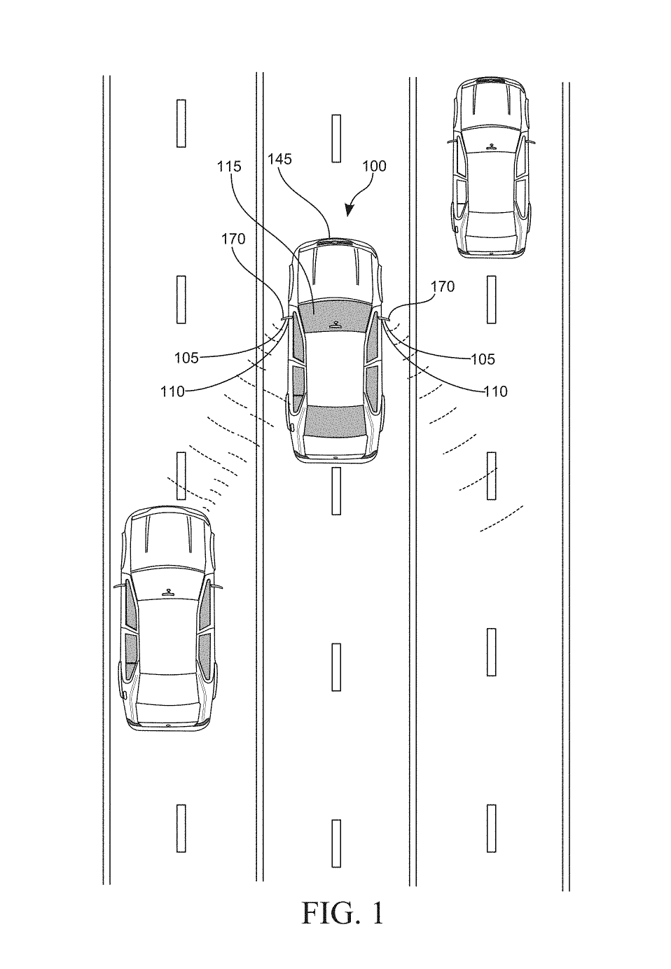

Referring to the drawings by numerals of reference there is shown in FIG. 1, an overhead view illustrating vehicle warning system 100 according to an embodiment of the present invention.

Vehicle warning system 100 may comprise at least one transmitter 105 adapted to be attached to side view mirrors 170 of automobile 145 and radiate waves outward therefrom, at least one receiver 110 adapted to be attached to portions of automobile 145 and receive the radiated waves sent by a respective transmitter 105 after being redirected by objects in proximity to automobile 145, warning member 115 that is electronically connected to receiver(s) 110 and adapted to provide a warning signal to a driver of automobile 145 when an object is detected in proximity to another automobile, and power source 120 connected to and adapted to provide electric power to transmitter(s) 105, receiver(s) 110, and warning member 115.

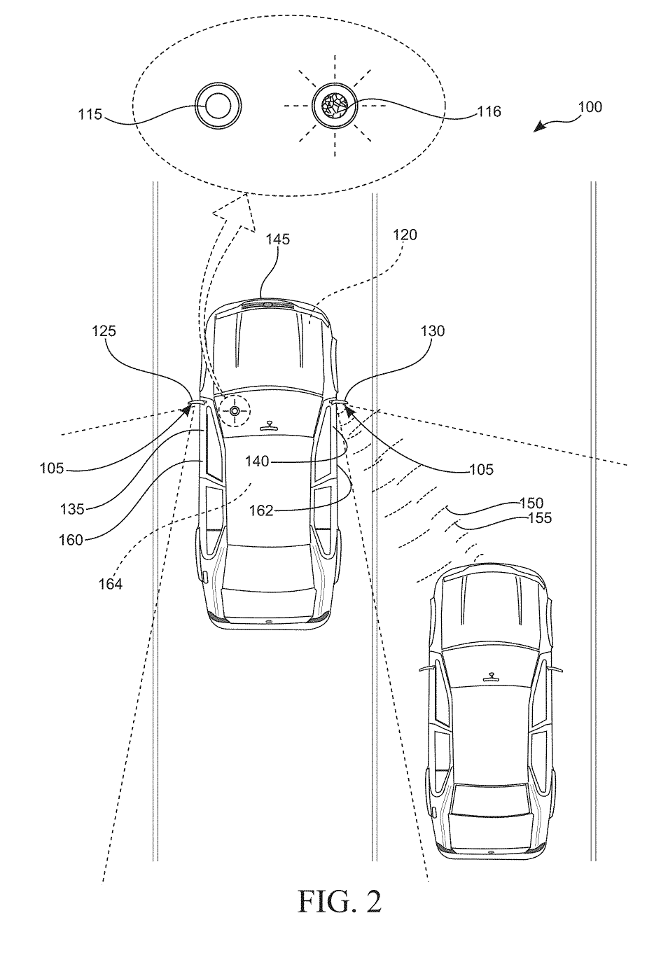

Referring now to FIG. 2, is a perspective view illustrating an in-use condition of vehicle warning system 100 according to an embodiment of the present invention of FIG. 1.

Warning member 115 is preferably formed as flashing yellow light member 116 but may be formed as an audible sound. The radiated waves from transmitter(s) 105 are preferably in the form of infrared light 150, but in some embodiments, the radiated waves may be in the form of electromagnetic radiation 155. The radiated waves reflect off of an adjacently located automobile and are again received by receiver(s) 110 which then activate warning member 115. Warning member 115 may be flashing yellow light member 116 located on the dash or may be an LCD display showing the location in proximity to automobile 145. There may also be an audible warning signal or any combination of the above.

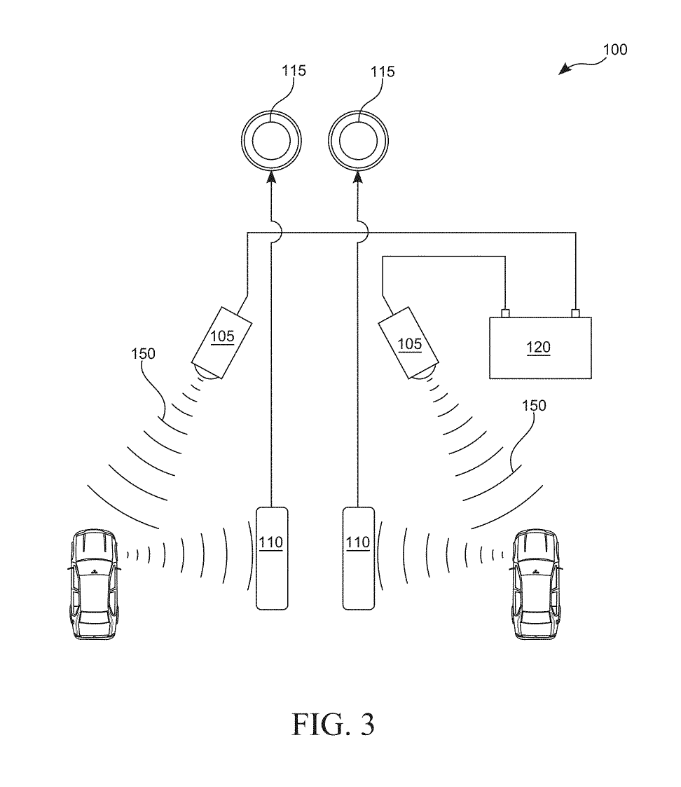

Referring now to FIG. 3, is a diagram illustrating vehicle warning system 100 according to an embodiment of the present invention of FIG. 1.

There is one transmitter(s) 105 attached to driver's side view mirror 125 and one attached to passenger's side view mirror 130. There are two receiver(s) 110, one attached to driver's side portion 135 of automobile 145 and one attached to passenger's side portion 140 of automobile 145. The two receiver(s) 110 may be attached to driver's side view mirror 125 and passenger's side view mirror 130 respectively.

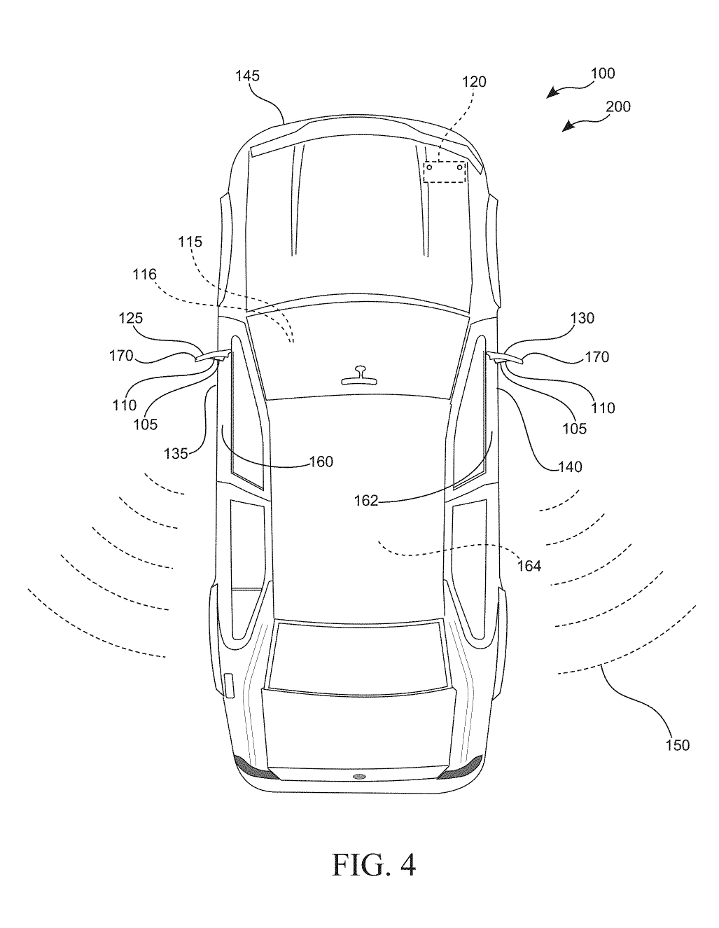

Referring now to FIG. 4, showing an overhead view illustrating combination of an automobile and a vehicle warning system 200 according to an embodiment of the present invention of FIG. 1.

The invention may be formed as combination of an automobile and a vehicle warning system 200 and may comprise automobile 145 having driver's side view mirror 125, passenger's side view mirror 130, driver's side door 160, passenger's side door 162, interior cabin 164, power source 120, and vehicle warning system 100 comprising at least one transmitter(s) 105 adapted to be attached to driver's side view mirror 125 and passenger's side view mirror 130 of automobile 145 to radiate waves therefrom, at least one receiver(s) 110 adapted to be attached to portions of automobile 145 and receive radiated waves sent by a respective transmitter(s) 105 after being redirected by objects in proximity to automobile 145, and warning member 115 electronically connected to at least one receiver(s) 110 that is located within interior cabin 164 of automobile 145 and adapted to provide a warning signal to a driver of automobile 145 when an object is detected in proximity to automobile 145.

Power source 120 of automobile 145 is connected to and adapted to provide electric power to transmitter(s) 105, receiver(s) 110, and warning member 115. There are two transmitter(s) 105 respectively attached to driver's side view mirror 125 and passenger's side view mirror 130 and there are two receiver(s) 110 respectively attached to driver's side door 160 of automobile 145 and passenger's side door 162 of automobile 145.

The two receiver(s) 110 may be respectively attached to driver's side view mirror 125 and passenger's side view mirror 130. Warning member 115 may be formed as flashing yellow light member 116, an audible sound, or may be formed as a lighted visual symbol. The radiated waves from transmitter(s) 105 may be in the form of infrared light 150 or may be in the form of electromagnetic radiation 155.

Vehicle warning system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other arrangements such as, for example, including more or less components, customized parts, different color combinations, parts may be sold separately, etc., may be sufficient.

Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A vehicle warning system comprising:
at least one transmitter;
wherein said at least one transmitter is adapted to be attached to side view mirrors of an automobile and radiate waves therefrom;
at least one receiver;
wherein said at least one receiver is adapted to be attached to portions of said automobile and receive said radiated waves sent by a respective said at least one transmitter after being redirected by objects in proximity to said automobile;
a warning member;
wherein said warning member is electronically connected to said at least one receiver and adapted to provide a warning signal to a driver of said automobile when an object is detected in proximity to said automobile; and
a power source;
wherein said power source is connected to and adapted to provide electric power to said at least one transmitter, said at least one receiver, and said warning member.

2. The vehicle warning system of claim 1, wherein there are two transmitters respectively attached to a driver's side view mirror and a passenger's side view mirror; and wherein there are two receivers respectively attached to a driver's side portion of said automobile and a passenger's side portion of said automobile.

3. The vehicle warning system of claim 2, wherein said two receivers are respectively attached to said driver's side view mirror and said passenger's side view mirror.

4. The vehicle warning system of claim 1, wherein said warning member is formed as a flashing yellow light member.

5. The vehicle warning system of claim 1, wherein said warning member is formed as an audible sound.

6. The vehicle warning system of claim 1, wherein said radiated waves from said at least one transmitter are in the form of infrared light.

7. The vehicle warning system of claim 1, wherein said radiated waves from said at least one transmitter are in the form of electromagnetic radiation.

8. A combination of an automobile and a vehicle warning system, said combination comprising:
an automobile including:
a driver's side view mirror;
a passenger's side view mirror;
a driver's side door;
a passenger's side door;
an interior cabin; and
a power source; and
a vehicle warning system comprising:
at least one transmitter;
wherein said at least one transmitter is adapted to be attached to said driver's and passenger's side view mirrors of said automobile and radiate waves therefrom;
at least one receiver;
wherein said at least one receiver is adapted to be attached to portions of said automobile and receive said radiated waves sent by a respective said at least one transmitter after being redirected by objects in proximity to said automobile;
a warning member;
wherein said warning member is electronically connected to said at least one receiver, is located within said interior cabin of said automobile, and adapted to provide a warning signal to a driver of said automobile when an object is detected in proximity to said automobile;
wherein said power source of said automobile is connected to and adapted to provide electric power to said at least one transmitter, said at least one receiver, and said warning member.

9. The combination of claim 8, wherein there are two transmitters respectively attached to said driver's side view mirror and said passenger's side view mirror; and wherein there are two receivers respectively attached to said driver's side door of said automobile and said passenger's side door of said automobile.

10. The combination of claim 9, wherein said two receivers are respectively attached to said driver's side view mirror and said passenger's side view mirror.

11. The combination of claim 8, wherein said warning member is formed as a flashing yellow light member.

12. The combination of claim 8, wherein said warning member is formed as an audible sound.

13. The combination of claim 8, wherein said radiated waves from said at least one transmitter are in the form of infrared light.

14. The combination of claim 8, wherein said radiated waves from said at least one transmitter are in the form of electromagnetic radiation.
